(19) United States
(12) Patent Application Publication
(10) Pub. No.: US 2017/0183529 A1
(43) Pub. Date: Jun. 29, 2017

(54) SELF-LEVELING PUTTY COMPOSITIONS

(71) Applicant: ARMSTRONG WORLD INDUSTRIES, INC., Lancaster, PA (US)

(72) Inventors: Gary A. Sigel, Columbia, PA (US); Burton L. Wilson, Pine Knot, KY (US)

(21) Appl. No.: 14/980,263

(22) Filed: Dec. 28, 2015

(51) Int. Cl. C09D 133/14; B05D 3/06

(52) U.S. Cl. CPC C09D 133/14; B05D 3/061

(57) ABSTRACT

Described herein are putty compositions having a first reactive component comprising a first acrylate oligomer and a second reactive component comprising a second acrylate oligomer that comprising a urethane acrylate oligomer, as well as an initiator component wherein the first acrylate oligomer and the second acrylate oligomer are present in a weight ratio that ranges from about 4:1 to about 1:2 and wherein the putty composition is self-leveling.

### FIELD OF THE DISCLOSURE

The present disclosure relates to wood substrates having surface defects treated with a putty composition having, inter alia, enhanced self-leveling characteristics.

### BACKGROUND

Currently, defects in cellulosic substrates are repaired by manually filling the defect with a curable composition. Subsequently, the composition is cured; the outer surface of the substrate is optionally sanded and subsequently coated. A disadvantage of this process is that it is performed manually and requires significant dry time. Filling the defects manually with a putty machine is a laborious process, which is expensive and time-consuming. In addition, the process is not suitable for a continuous production process.

Thus, there remains a need for compositions suitable for use in a continuous process which provides—inter alia—through-cure of putty compositions used to repair defects in cellulosic substrates. Embodiments of the present invention are directed to meeting these needs.

### SUMMARY

In some embodiments, the present invention provides a composite panel comprising a first major surface opposite a second major surface, the composite panel further comprising: a cellulosic substrate comprising a top surface opposite a bottom surface, the top surface forming a part of the first major surface, the cellulosic substrate comprising at least one defect that forms a depression in the top surface of the cellulosic substrate; and a cured polymeric composition formed from a putty composition comprising a first reactive component comprising a first acrylate oligomer; a second reactive component comprising a second acrylate oligomer, the second acrylate oligomer comprising a urethane acrylate oligomer; and an initiator component comprising a thermal initiator and a photo initiator, wherein the first reactive component and the second reactive component are present in a weight ratio ranging from about 4:1 to about 1:2; and wherein the putty composition is self-leveling; and wherein the cured polymeric composition occupies at least a portion of the depression.

In other embodiments, the present invention provides a method of repairing cellulosic substrate comprising: (a) heating a cellulosic substrate having at least one defect that forms a depression in a top surface of the cellulosic substrate to a temperature of greater than about 35° C.; (b) applying a putty composition to the depression, the putty composition comprising: a first reactive component comprising a first acrylate oligomer; a second reactive component comprising a second acrylate oligomer, the second acrylate oligomer comprising a urethane acrylate oligomer; and an initiator component comprising a thermal initiator and a photo initiator, wherein the content ratio of the first acrylate oligomer to the second acrylate oligomer ranges from about 4:1 to about 1:2; and wherein the putty composition is self-leveling; and (c) exposing the cellulosic substrate to a radiation source.

In other embodiments, the present invention provides a putty composition comprising: a first acrylate oligomer comprising a polyester acrylate oligomer, an epoxy acrylate oligomer, or a combination thereof; a second acrylate oligomer comprising a urethane acrylate oligomer; and an initiator component comprising: a thermal initiator; and a photo initiator; wherein the first acrylate oligomer and the second acrylate oligomer are present in a weight ratio that ranges from about 4:1 to about 1:2; and wherein the putty composition is self-leveling; and wherein the putty composition has a viscosity ranging from about 500 cP to about 10,000 cP at about 25° C.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a composite panel containing surface defects that have been treated according to the present invention;

FIG. 2 is a cross-sectional view of the cellulosic substrate taken along line II-II in FIG. 1;

FIG. 3 is a cross-sectional view of the composite panel taken along line II-II in FIG. 1.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material. According to the present invention, the term “about” means+/−5% of the referenced value. According to the present invention, the phrase “substantially free” means less than 0.5 wt. % based on the referenced amount.

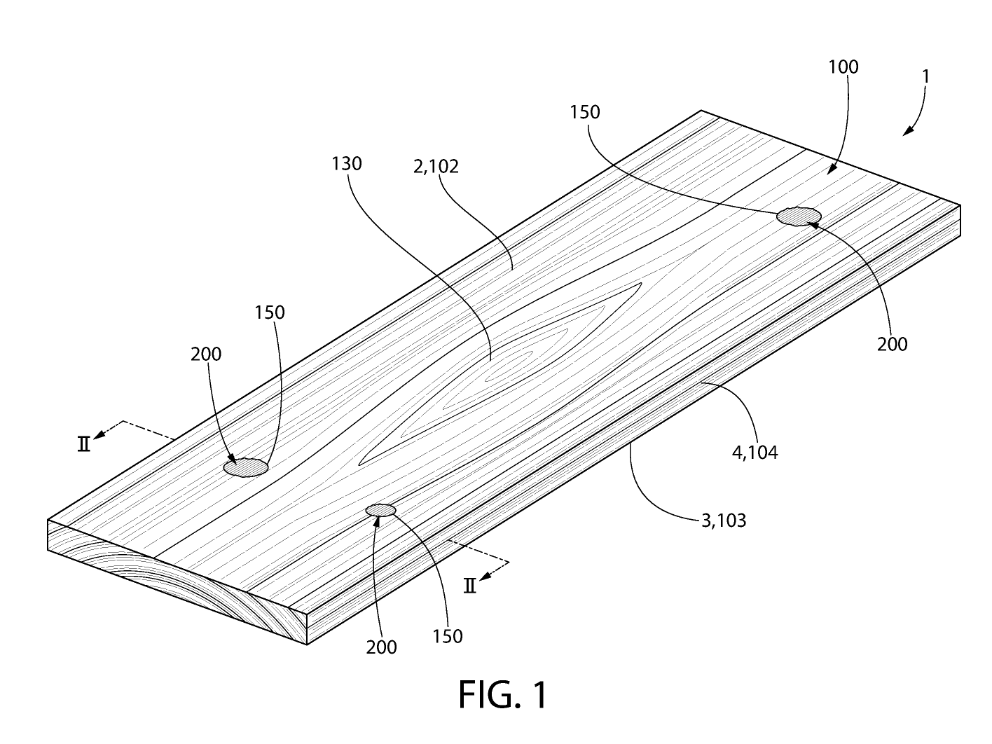

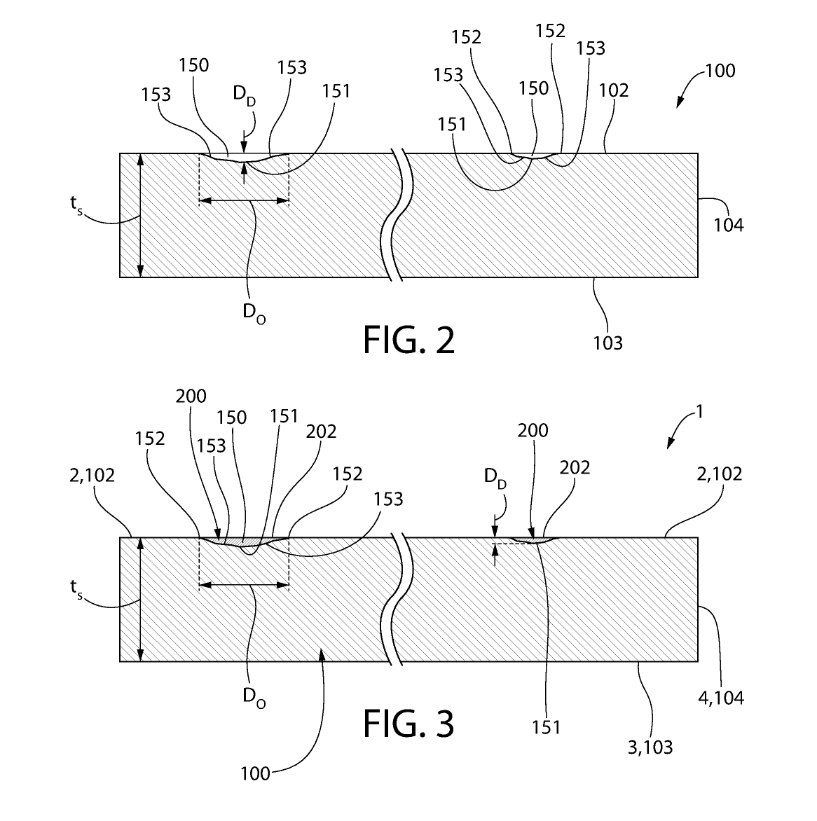

Referring to FIGS. 1-3 concurrently, the present invention provides a composite panel 1 comprising a cellulosic substrate 100 and cured polymeric composition 200. The composite panel 1 may comprise a first major surface 2 opposite a second major surface 3 and side major surfaces extending there-between 4. The cellulosic substrate 100 may be formed from wood and comprise a top surface 102 opposite a bottom surface 103 and side surfaces 104 extending there-between. The cellulosic substrate 100 may also comprise natural design features 130, such as a knot, burl, wood-grain, or the like. The cellulosic substrate 100 may have a thickness t_{S} ranging from about 180 mils to about 1000 mils as measured from the top surface 102 to the bottom surface 103—including all values and sub-ranges there-between. The composite panel 1 may also have a thickness that is substantially equal to the thickness t_{S} of the cellulosic substrate 100.

The cellulosic substrate 100 may comprise surface defects 150 that form depressions in the top surface 102 of the cellulosic substrate 100. Each depression 150 may comprise a floor 151 and side walls 153—with the floor 151 being the deepest point of the depression 150. The defects 150 may have a defect depth D_{D} as measured from the top surface 102 of the cellulosic substrate 100 to the floor 151 of the defect 150, where the defect depth D_{D} ranges from about 1 mil to about 100 mils—including all values and sub-ranges there-between. The side walls 153 may extend upward from the floor 151 and intersect with the top surface 102 to the cellulosic substrate 100 at an intersection point 152—wherein the side walls 153 may extend upward in a direction that is perpendicular or orthogonal to the top surface 102 of the cellulosic substrate 100. Each of the depressions 150 may have an opening distance D_{O} which is the distance measured between the intersection points 152 that exist on opposite side walls 153 for a single depression 150 in the cellulosic substrate 100. The opening distance D_{O} of may range from about 0.1 inches to about 2.0 inches—including all values and sub-ranges there-between.

According to the present invention, the defects 150 on the cellulosic substrate 100 may be repaired by filling the void created by each depression 150 with a putty composition which is cured to form a cured polymeric composition 200, thereby producing the composite panel 1 of the present invention. As used herein, the term “putty” refers to a soft, sticky, dough-like material that hardens after it is cured.

As demonstrated in FIG. 3, the cured composition 200 may form a top repair surface 202 that faces the same direction as the top surface 102 of the cellulosic substrate. The top repair surface 202 of the cured polymeric composition 200 and the top surface 102 of the cellulosic substrate 100 may each form a part of the first major surface 2 of the composite panel. The top repair surface 202 may be substantially parallel to the top surface 102. The top repair surface 202 may be substantially co-planar with the top surface 102.

The putty composition of the present invention comprises a blend of first reactive component and a second reactive component. The first reactive component may comprise a first acrylate oligomer and, optionally, a reactive diluent. The second reactive component may comprise a second acrylate oligomer and, optionally, a reactive diluent. Each of the first and second acrylate oligomers may be a linear or branched compound having an acrylate functionality (the term “acrylate” as described herein refers to compounds having either acrylate and/or (meth)acrylate functionality) ranging from about 2 to 9—including all values and sub-ranges there-between. The reactive diluent may be one or more compounds having an acrylate functionality ranging from about 1 to 5—including all values and sub-ranges there-between. Together, the first reactive component and the second reactive component react to form a polymer alloy that is particularly suitable as wood putty—as described further herein.

The first reactive component comprising the first acrylate oligomer creates may be an adhering oligomer and may comprise an epoxy acrylate oligomer, a polyester acrylate oligomer, or a combination thereof. The term adhering oligomer refers to reactive composition that, when cured, provides rigidity and hardness to the cured polymeric composition 200. The second acrylate oligomer may be a flexible oligomer and may comprise a urethane acrylate oligomer. The term flexible oligomer refers to reactive composition that, when cured, decreases the likelihood of cracking in the cured polymeric composition 200. The combination of the first and second acrylate oligomers create a polymer alloy exhibiting rigidity and flexibility required to for the resulting cured polymeric composition to be post-processed using various mechanical means (as described further herein), without risk of cracking that would undermine the putty's ability to repair defects in cellulosic substrates.

The first reactive component and the second reactive component may be present in a weight ratio ranging from about 4:1 to 0:1—i.e. in some embodiments the first reactive component may be optional. In other embodiments, the weight ratio of the first reactive component to the second reactive component may range from about 4:1 to about 1:2—including all ratios and sub-ranges there-between. In a preferred embodiment, the weight ratio of the first reactive component to the second reactive component may range from about 2:1 to about 1:1—including all ratios and sub-ranges there-between.

The first reactive component may be present in an amount ranging from about 40 wt. % to about 87 wt. % based on the total weight of the putty composition—including all values and sub-ranges there-between. In other embodiments, the first reactive component may be present in an amount ranging from about 50 wt. % to about 70 wt. % based on the total weight of the putty composition—including all values and sub-ranges there-between. In other embodiments, the reactive component may be present in an amount ranging from about 55 wt. % to about 65 wt. % based on the total weight of the putty composition—including all values and sub-ranges there-between

The first reactive component may comprise a polyester acrylate oligomer that is the reaction product of polyester polyol and a carboxylic acid functional acrylate compound such as acrylic acid, (meth)acrylic acid, or a combination thereof—at an OH:COOH ratio of about 1:1. The polyester polyol may have a hydroxyl functionality ranging from 2 to 9—including all values and sub-ranges there-between.

The polyester polyol may be the reaction product of a hydroxyl-functional compound and a carboxylic acid functional compound. The hydroxyl-functional compound is present in a stoichiometric excess to the carboxylic-acid compound. The hydroxyl-functional compound may be a polyol, such a diol or a tri-functional or higher polyol (e.g. triol, tetrol, etc.). The polyol may be aromatic, cycloaliphatic, aliphatic, or a combination thereof. The carboxylic acid-functional compound may be a dicarboxylic acid, a polycarboxylic acid, or a combination thereof. The dicarboxylic acid and polycarboxylic acid may each be aliphatic, cycloaliphatic, aromatic, or a combination thereof.

The diol may be an alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediol including 1,2-propanediol, 1,3-propanediol, butyl ethyl propanediol, 2-methyl-1,3-propanediol, and 2-ethyl-2-butyl-1,3-propanediol; butanediol including 1,4-butanediol, 1,3-butanediol, and 2-ethyl-1,4-butanediol; pentanediol including trimethyl pentanediol and 2-methylpentanediol; cyclohexanedimethanol; hexanediol including 1,6-hexanediol; caprolactonediol (for example, the reaction product of epsilon-caprolactone and ethylene glycol); hydroxy-alkylated bisphenol; polyether glycols, for example, poly(oxytetramethylene)glycol. In some embodiments, the tri-functional or higher polyol may be selected from trimethylol propane, pentaerythritol, di-pentaerythritol, trimethylol ethane, trimethylol butane, dimethylol cyclohexane, glycerol and the like.

The dicarboxylic acid may be selected from adipic acid, azelaic acid, sebacic acid, succinic acid, glutaric acid, decanoic diacid, dodecanoic diacid, phthalic acid, isophthalic acid, 5-tert-butylisophthalic acid, tetrahydrophthalic acid, terephthalic acid, hexahydrophthalic acid, methylhexahydrophthalic acid, dimethyl terephthalate, 2,5-furandicarboxylic acid, 2,3-furandicarboxylic acid, 2,4-furandicarboxylic acid, 3,4-furandicarboxylic acid, 2,3,5-furantricarboxylic acid, 2,3,4,5-furantetracarboxylic acid, cyclohexane dicarboxylic acid, chlorendic anhydride, 1,3-cyclohexane dicarboxylic acid, 1,4-cyclohexane dicarboxylic acid, and anhydrides thereof, and mixtures thereof. In some embodiments the polycarboxylic acid may be selected from trimellitic acid and anhydrides thereof.

Commercially available polyester acrylate oligomer include polyester-acrylate resins such as: Craynor® UVP-215, Craynor® UVP-220 (both ex Cray Valley), Genomer® 3302, Genomer® 3316 (both ex Rahn),), Sartomer CN2261, CN9005, Laromer® PE 44F, Laromer PE 56F, Laromer 8992, Laromer 8800 (ex BASF), Ebecryl® 800, Ebecryl® 810, Viaktin® 5979, Viaktin® VTE 5969, and Viaktin® 6164 (100%).

The first reactive component may comprise an epoxy acrylate oligomer. The epoxy acrylate oligomer may be prepared by reacting epichlorohydrin with bisphenol A to form diglycidyl ethers of bisphenol, followed by reacting the diglycidyl ether of bisphenol product with acrylic acid and/or (meth)acrylic acid. The epoxy acrylate oligomer may be an aliphatic epoxy acrylate oligomer or an aromatic epoxy acrylate oligomer. The backbone of an aromatic epoxy acrylate oligomer may comprise an epoxy compound that includes one to three 1,2-epoxy groups per molecule, and preferably, from about two to about two and one half (2.5) 1,2-epoxy groups per molecule. A non-limiting example of the epoxy acrylate oligomer may be a glycidyl ether of a polyhydric phenol and polyhydric alcohol having an epoxide equivalent weight of from about 100 to about 500. The polyhydric phenol may be bisphenol-A, bisphenol-F, or a combination thereof.

In other embodiments, the epoxy acrylate oligomer may comprise a diglycidyl ether of tetrabromobisphenol A, epoxy novolacs based on phenol-formaldehyde condensates, epoxy novolacs based on phenol-cresol condensates, epoxy novolacs based on phenol-dicyclopentadiene condensates, diglycidyl ether of hydrogenated bisphenol A, digylcidyl ether of resorcinol, tetraglycidyl ether of sorbitol, and tetra glycidyl ether of methylene dianiline, as well as mixtures of two or more thereof.

The second acrylate oligomer may be present in an amount ranging from about 12.5 wt. % to about 55 wt. % based on the total weight of the putty composition—including all values and sub-ranges there-between In other embodiments, the second acrylate oligomer may be present in an amount ranging from about 20 wt. % to about 50 wt. % based on the total weight of the putty composition—including all values and sub-ranges there-between. In other embodiments, the second acrylate oligomer may be present in an amount ranging from about 25 wt. % to about 45 wt. % based on the total weight of the putty composition—including all values and sub-ranges there-between. In a preferred embodiment, the second acrylate oligomer may be present in an amount ranging from about 20 wt. % to about 40 wt. % based on the total weight of the putty composition—including all values and sub-ranges there-between.

The second acrylate oligomer may comprise a urethane acrylate oligomer. The urethane acrylate oligomer may have an average acrylate functionality ranging from about 2 to about 4—including all values and sub-ranges there-between.

The urethane acrylate oligomer may be the reaction product of polyisocyanate, one or more high molecular weight polyol, and a hydroxyl-functional acrylate. The urethane acrylate oligomer may be produced by reacting the polyisocyanate and the hydroxyl-functional compounds at an NCO:OH ratio ranging from about 0.8:1 to about 1.2:1—preferably at about 1:1.

The polyisocyanate may have an isocyanate-functionality ranging from about 2 to about 4. Non-limiting examples of polyisocyanate include aliphatic polyisocyanate, cycloaliphatic polyisocyanate, and/or aromatic polyisocyanate—such as 1,4-tetramethylene diisocyanate, 1,6-hexamethylene diisocyanate, 1,4-cyclohexyl diisocyanate and isophorone diisocyanate, 4,4′ diphenyl-methane diisocyanate and toluene diisocyanates. Polyisocyanate having an isocyanate functionality of 3 or 4 may include triisocyanates and isocyanurates of 1,6-hexamethylene-diisocyanate and isophorone diisocyanate may be used.

The high molecular weight polyol may have a hydroxyl functionality ranging from about 2 to about 4. Non-limiting examples of high molecular weight polyol include polyester polyol, polyether polyol, polyolefin polyol, and polycarbonate polyol having an average hydroxyl functionality ranging from about 2 to about 4. The polyester polyol used to create the urethane acrylate oligomer may be the same as the polyester polyol used to form the polyester acrylate oligomer.

The hydroxyl-functional acrylate may have a hydroxyl functionality from about 1 to about 2 and an acrylate functionality from about 1 to about 3. Non-limiting examples of hydroxyl functional acrylate include the reaction product of acrylic acid and/or (meth)acrylic acid and a low molecular weight diol or polyol. In some embodiments, the low molecular weight diol is selected from monoethylene glycol, 1,2- and 1,3-propylene glycol, 1,4- and 2,3-butylene glycol, 1-pentanediol, 1,6-hexanediol, 1,8-octanediol, decanediol, dodecanediol, neopentylglycol, cyclohexanediol and mixtures thereof. In some embodiments, the polyol is selected from pentaerythritol, neopentylglycol, dicidol, trimethylolpropane, and mixtures thereof. In some embodiments, the diol and polyol may contain alkyl branching or hydroxylalkyl branching such as trimethylolpropane. In other embodiments, the polyol comprises a mixture of a polyol having a hydroxyl functionality of three or greater and a diol. In other embodiments, the polyol may have a chain length of from C₂ to C₄ or from C₂ to C₃, between the hydroxyl groups.

Each of the first reactive component and the second reactive component may independently comprise a reactive diluent. The reactive diluent may be present in the first reactive component in an amount ranging from about 0 wt. % to about 20 wt. % based on the total weight of each of the first reactive component. The reactive diluent may be present in the second reactive component in an amount ranging from about 0 wt. % to about 20 wt. % based on the total weight of each of the second reactive component.

Reactive diluents are compounds that serve a dual purpose: such compounds are not only capable of covalently bonding with acrylate-functional oligomer but are also capable of reducing the viscosity of the overall putty composition. The reactive diluents may have number average molecular weights of about 226 to about 2000—including all values and sub-ranges there-between. The reactive diluent may have an acrylate functionality ranging from 1 to 5—including all values and sub-ranges there-between.

Suitable reactive diluents include, but are not limited to, (meth)acrylic acid, isodecyl(meth)acrylate, N-vinyl formamide, isobornyl(meth)acrylate, tetraethylene glycol (meth)acrylate, tripropylene glycol (meth)acrylate, hexanediol di(meth)acrylate, ethoxylate bisphenol-A di(meth)acrylate, ethoxylated neopentyl glycol di(meth)acrylate, propoxylated neopentyl glycol di(meth)acrylate, ethoxylated tripropylene glycol di(meth)acrylate, glyceryl propoxylated tri(meth)acrylate, tris(2-hydroxy ethyl) isocyanurate tri(meth)acrylate, pentaerythritol tri(meth)acrylate, pentaerythritol tetra(meth)acrylate, dimethylol propane tri(meth)acrylate dipentaerythritol monohydroxypenta(meth)acrylate, and trimethylol propane tri(meth)acrylate and its ethoxylated and propoxylated analogues of the skeletal structures in Formula 3:

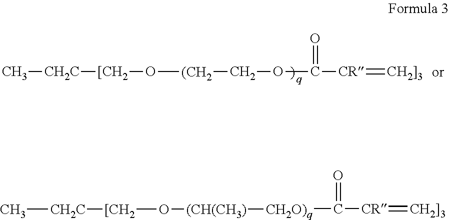

Where R″=H, or CH₃, and q=0, 1, 2, 3, 4, 5, 6, 7, 8, 9 or 10.

The preferred (meth)acrylate reactive diluents are the multifunctional acrylates with number average molecular weights of about 226 to about 2000. Examples of such are tetraethylene glycol diacrylate with a molecular weight of about 302, ethoxylated bisphenol-A diacrylate with a number average molecular weight of about 776 (SR602 from Sartomer Company), trihydroxyethyl isocyanurate triacrylate with molecular weight of about 423 (SR368 from Sartomer), trimethylol propane triacrylate with a number average molecular weight of about 296 (SR351 from Sartomer), and ethoxylated trimethylol propane triacrylates with number average molecular weights from about 400 to about 2000 (SR454, SR499, SR502, SR9035, and SR 415 from Sartomer Company and Photomer 4155 and Photomer 4158 from Henkel Corporation). Tetra-functional reactive diluent may comprise pentaeryhritol tetraacrylate. Penta-functional reactive diluent may comprise dipentaeryhritol pentaacrylate.

Additionally, when the reactive composition comprises an epoxy-based oligomer, the reactive composition may further comprise an epoxy flexibilizer. Non-limiting examples of flexibilizer includes rubber-modified bisphenol A epoxies, epoxidized castor oil based epoxies, and epoxies which are modified with dimerized fatty acids, as well as mixtures thereof.

The putty composition further comprises an initiator component comprising a mixture of thermal initiator and a photo initiator. The mixture of thermal initiator and photo initiator provides a dual cure mechanism to the putty composition (e.g., curing by heat and UV radiation) that ensures fast and proper through-cure of the putty composition to form the cured polymeric composition 200. The term “through-cure” indicates that the substantially all of the putty composition that has been applied to one or more defects 150 in the cellulosic substrate 100 has been chemically cured by cross-linking of the free acrylate groups present on the first acrylate oligomer and the second acrylate oligomer (and, optionally, the third acrylate oligomer), thereby forming the cured polymeric composition 200.

The dual cure mechanism of the present invention results in through-cure for putty compositions applied to depressions having a defect depths D_{D} as high at 10 mils. Unlike the soft, sticky, dough-like putty composition, the cured polymeric composition 200 is a rigid, non-tacky material at room temperature that has a hardness of at least the surrounding cellulosic substrate 100. Therefore, the dual cure mechanism provides fast and efficient formation of the cured polymeric composition 200 throughout the substantially the entire defect 150 (up to defect depths D_{D} of 100 mils), which in-turn allows for fast and efficient post-processing of the composite panel 1 (e.g., milling, surface sanding, abrading, etc.) as the cured polymeric composition 200 can quickly be post-treated in the same way that cellulosic substrate 100 without special concern to a partially cured putty composition.

The thermal initiator may be present in an amount ranging from about 0.05 wt. % to about 2 wt. % based on the total weight of the putty composition—including all values and sub-ranges there-between. In some embodiments, the thermal initiator may be present in an amount ranging from about 0.1 wt. % to about 1.5 wt. % based on the total weight of the putty composition—including all values and sub-ranges there-between. In other embodiments, the thermal initiator may be present in an amount ranging from about 0.2 wt. % to about 1.25 wt. % based on the total weight of the putty composition—including all values and sub-ranges there-between. In further embodiments, the thermal initiator may be present in an amount ranging from about 0.3 wt. % to about 1.25 wt. % based on the total weight of the putty composition—including all values and sub-ranges there-between. In other embodiments, the thermal initiator may be present in an amount of about 0.5 wt. % based on the total weight of the putty composition. In other embodiments, the thermal initiator may be present in an amount of about 0.6 wt. % based on the total weight of the putty composition. In other embodiments, the thermal initiator may be present in an amount of about 0.7 wt. % based on the total weight of the putty composition. In other embodiments, the thermal initiator may be present in an amount of about 1.1 wt. % based on the total weight of the putty composition.

The thermal initiator may comprise a free radical initiator that generates radicals upon exposure to heat rather than light. The thermal initiator may be selected from a peroxide compound, an azo compound, and a combination thereof. Non-limiting examples of azo compounds include 2,2′-azobis-(2,4-dimethylvaleronitrile), azobisisobutyronitrile, azobisisoheptanonitrile, azobisisopentanonitrile, and 2,2′-azobis-(2-methylbutyronitrile); 1,1′-azobis-(1-cyclohexanecarbonitrile).

Non-limiting examples of peroxide initiators include diacyl peroxides, such as 2-4-diclorobenzyl peroxide, diisononanoyl peroxide, decanoyl peroxide, lauroyl peroxide, succinic acid peroxide, acetyl peroxide, benzoyl peroxide, and diisobutyryl peroxide, acetyl alkylsulfonyl peroxides, such as acetyl cyclohexylsulfonyl peroxide, dialkyl peroxydicarbonates, such as di(n-propyl) peroxydicarbonate, di(sec-butyl) peroxydicarbonate, di(2-ethylhexyl) peroxydicarbonate, t-butyl-peroxymaleic acid, diisopropyl peroxydicarbonate, and dicyclohexyl peroxydicarbonate, peroxy esters such as alpha-cumyl peroxyneodecanoate, alpha-cumyl peroxypivalate, t-amyl peroxyneodecanoate, t-butyl peroxyneodecanoate, t-amyl peroxypivalate, t-butyl peroxypivalate, 2,5-dimethyl-2,5-di(2-ethylhexanoylperoxy)hexane, t-amylperoxy-2-ethyl hexanoate, t-butyl peroxy-2-ethyl hexanoate, t-butyl peroxyisobutyrate, t-butyl peroxyacetate, t-butyl peroxybenzoate, di-t-butyl diperoxy azelate, and di-t-butyl diperoxy phthalate, dicumyl peroxide, 2,5-dimethyl-2,5-di(t-butylperoxy)hexane, t-butyl cumyl peroxide, di-t-butyl peroxide, and 2,5-dimethyl, 2,5-di(t-butylperoxy)hexyne-3, a hydroperoxide, such as 2,5-dihydroperoxy-2,5-dimethyl hexane, cumene hydroperoxide, t-butyl hydroperoxide and t-amyl hydroperoxide, n-butyl-4,4-bis-(t-butylperoxy)valerate, 1,1-di(t-butylperoxy)-3,3,5-trimethyl cyclohexane, 1,1′-di-t-amyl-peroxy cyclohexane, 2,2-di(t-butylperoxy) butane, ethyl-3,3-di(t-butylperoxy)butyrate, t-butyl peroctoate, and 1,1-di(t-butylperoxy)cyclohexane.

The photo initiator may be water soluble and include benzophenone-type initiators, phosphine oxides, acetophenone derivatives, and cationic photo initiators such as triaryl sulfonium salts and aryliodonium salts. The photo initiator may be selected from benzophenone; 4-methylbenzophenone; benzyl dimethyl ketal; diethoxy acetophenone; benzoin ethers; thioxanthones; 1-hydroxycyclohexyl phenyl ketone; 2-hydroxy-2-methyl-1-phenol-propane-1-one; 4-(2-hydroxyethoxy)phenyl-(2-hydroxy-2-methylpropyl) ketone; 2,4,6-trimethylbenzoyl diphenylphosphine oxide; bis(2,6-dimethoxybenzoyl)-2,4,4-trimethylpentyl phosphine oxide; 2,2-dimethoxy-2-phenyl acetophenone; 2,2-dimethoxy-1,2-diphenylethan-1-one; bis(2,4,6-trimethylbenzoyl)-phenyl phosphineoxide; 2-benzyl-2-N,N-dimethylamino-1-(4-morpholinophenyl)-1-butanone; and 2-methyl-1-[4-(methylthio)phenyl]-2-morpholino propan-1-one, and a combination of two or more thereof.

The photo initiator may be used alone or in combination with other photo initiators. The putty composition may further comprise photosensitizers. Non-limiting examples of photosensitizer include isopropyl thioxanthone, chlorothioxanthone, quinones such as camphorquinone; 4,4′-bis(dimethylamino)benzophenone; 4,4′-bisdiethylamino benzophenone ethyl ketone; thioxanthone, benzanthrone, triphenyl acetophenone and fluorenone, dimethylethanolamine, methyldiethanolamine, triethanolamine, N,N-dimethyl-para-toluidine, N-[2-hydroxyethyl]-N-methyl-para-toluidine, octyl-para-N,N-dimethylamino benzoate, and ethyl-para-N,N-dimethylamino benzoate.

The putty composition of the present invention may be substantially free of thiol-functional compounds. According to some embodiments, the putty composition of the present invention may be entirely free of thiol-functional compounds (i.e. comprise 0 wt. % of thiol-functional compounds based on the total weight of the putty composition). The putty composition of the present invention ensures fast and proper through-cure of the putty composition to form the cured polymeric composition 200 even without the addition of thiol-functional compounds, such as trithiol.

The putty composition may further comprise a solvent. Non-limiting examples of solvent include an aromatic solvent, such as toluene or benzene; and a non-aromatic solvent, such as acetone, chloroform, dichloromethane, ethylacetate, or methyl methacrylate. In some embodiments, the solvent comprises acetone.

The solvent may be present in an amount ranging from about 0.5 wt. % to about 5 wt. % based on the total weight of the putty composition—including all values and sub-ranges there-between. In other embodiments, the solvent may be present in an amount ranging from about 1 wt. % to about 3 wt. % based on the total weight of the putty composition—including all values and sub-ranges there-between. In other embodiments, the solvent may be present in an amount ranging from about 1.2 wt. % to about 2.8 wt. % based on the total weight of the putty composition—including all values and sub-ranges there-between. In some embodiments, the solvent may be present in an amount of about 1.2 wt. % based on the total weight of the putty composition. In some embodiments, the solvent may be present in an amount of about 1.8 wt. % based on the total weight of the putty composition. In some embodiments, the solvent may be present in an amount of about 2.6 wt. % based on the total weight of the putty composition.

The solvent and the thermal initiator may be present in the putty composition in a weight ratio that ranges from about 5:1 to about 1:1—including all ratios and sub-ranges there-between. In a preferred embodiment the solvent and the thermal initiator may be preset in the putty composition in a weight ratio ranging from about 4:1 to about 2.5:1—including all ratios and sub-ranges there-between.

When preparing the putty composition of the present invention, the thermal initiator and solvent may be pre-blended before being added to the first and second acrylate oligomers. Specifically, the thermal initiator may be substantially dissolved in the solvent prior to being added to the first and second acrylate oligomers.

The putty composition of the present invention may further comprise pigments and colorant and, optionally, surfactant. The pigment may be present in an amount ranging from about 3 wt. % to about 8 wt. % based on the total weight of the putty composition—including all values and sub-ranges there-between. The pigment may include particles that impart yellow, red, green, blue, black, and combinations thereof, to the putty composition. The surfactant may be present in an amount ranging from about 0.1 wt. % to about 1 wt. % based on the total weight of the putty composition—including all values and sub-ranges there-between.

In preferred embodiments of the present invention, the putty composition may be substantially free of filler. In alternative embodiments, the putty composition may comprise filler. Non-limiting examples of filler include glass flit, flour, calcium carbonate, barium sulfate, mica, ammonium chloride, ammonium bromide, boric acid, antimony trioxide, alumina (e.g. fumed alumina), clays such as kaolin, china clay, lithopone, zinc sulfide, zirconium oxide, barium oxide, calcium oxide or hydroxide, magnesium silicate, oxide or hydroxide, ceramic, hollow glass, resin microspheres, pearl essence, barytes, diatomaceous earth, aluminum trihydrate, onyx flour, magnesium silicate (“talc”), calcium silicate, mixed silicates, and the like.

The putty composition of the present invention may have a Brookfield viscosity ranging from about 500 cP to about 10,000 cP, at about 25° C. In other embodiments, the putty composition may have a Brookfield viscosity of from about 1,000 cP to about 5,000 cP, at about 25° C. In other embodiments, the putty compositions may have a Brookfield viscosity of from about 2,000 cP to about 5,000 cP, at about 25° C. The putty composition may further comprise a viscosity modifying agent in an amount effective such that the putty composition exhibits the desired viscosity. Non-limiting examples of viscosity modifying agent comprises fumed silica and/or a dispersant.

The putty composition of the present invention is formulated to be self-leveling. The term “self-leveling” refers to a composition that can fill one or more depressions 150 on the cellulosic substrate 100 under the effect of only gravity and without the need for using physical tools (e.g., a putty knives, air blade, vacuum suction) to further manipulate the putty composition after application to the cellulosic substrate 100. Specifically, self-leveling will cause the putty composition to settle within the depression 150 and form a putty top surface that is substantially parallel to the top surface 102 of the cellulosic substrate 100 under the effect of only gravity.

After curing, the top surface of the putty composition becomes the top repair surface 202 of the cured polymeric composition 200. Therefore, the self-leveling of the putty composition provides a fast and efficient way to create a desirable the top repair surface 202 because the application of the putty composition can be immediately followed by initiation of the dual curing mechanism without the need for intermittent physical manipulation of the putty composition that would otherwise be required to ensure the resulting top repair surface 202 is parallel to the top surface 102 of the cellulosic substrate 100. Furthermore, with an effective amount of putty composition applied to the defect 150, the self-leveling can provide a top repair surface 202 that is substantially co-planar with the top surface 102 of the cellulosic substrate without need for additional processing, such as sanding or abrading of the cured polymeric composition 200, thereby reducing manufacturing time and energy, as well as saving on material cost.

The putty composition may be formed by combining the first acrylate oligomer, second acrylate oligomer, thermal and photo initiators, solvent, and optionally, pigments, and surfactant. In some embodiments, the thermal initiator may be pre-dissolved in the solvent before being added to the other components of the putty composition.

The composite panel 1 may be formed by heating a cellulosic substrate 100 that has at least one defect 150 on the top surface 102 to a temperature of greater than about 35° C. In some embodiments, the cellulosic substrate may be heated to a temperature of from about 37° C. to about 70° C. In other embodiments, the cellulosic substrate may be heated to a temperature of from about 57° C. to about 66° C. The bottom surface 103 of the cellulosic substrate 100 may face an upper surface of a conveyor belt or other work surface. The putty composition may be applied to the defect 150, where the putty composition then self-levels under gravitational pull (whereby gravity is pulling in a direction extending from the top surface 102 toward the bottom surface 103 of the cellulosic substrate 100). The putty composition may be at room temperature when it self-levels.

During one or more stages of the manufacturing process, the cellulosic substrate 100 may be placed on a conveyor belt that has a line speed of from about 10 feet/minute (fpm) to about 70 fpm—including all values and sub-ranges there-between. In some embodiments, the conveyor belt has a line speed of from about 20 fpm to about 60 fpm—including all values and sub-ranges there-between. In some embodiments, the conveyor belt has a line speed of from about 30 fpm to about 50 fpm—including all values and sub-ranges there-between. In some embodiments, the conveyor belt has a line speed of about 35 fpm. In some embodiments, the conveyor belt has a line speed of 33 fpm. Specifically, the self-leveling and dual cure mechanism of the putty composition allows for faster manufacture of the composite panel 1.

Once the putty composition is applied to the defect 150, the putty composition self-levels to form the putty top surface without the need for the application of external pressure on the putty top surface from an external top layer or top film. The cellulosic substrate 100 may then be exposed to a radiation source and the putty composition cures to form the cured polymeric composition 200 within the cellulosic substrate 100, thereby forming the composite panel 1 of the present invention. The putty top surface may be exposed to atmospheric conditions during curing. Stated otherwise, the putty top surface is not covered by an external membrane or protective film/layer during exposure to the UV radiation during curing. Rather, the putty top surface of the putty composition and at least a portion of the top surface 102 of the cellulosic substrate 100 are exposed to the surrounding atmospheric conditions during curing. Thus the top putty surface forms the top repair surface 202 while exposed to atmospheric conditions and not under the protection of an external layer and/or membrane.

The cellulosic substrate 100 having the putty composition applied thereto can be cured by conveying the cellulosic substrate 100 along the machine direction wherein the radiation source is located above the cellulosic substrate 100 and conveyor belt, facing downward. As the cellulosic substrate 100 and putty composition applied there to pass underneath the radiation source, the putty composition is exposed to the UV radiation that is emitted from the radiation source.

The radiation source may comprise ultraviolet radiation as measured using an EIT radiometer in the UVA regime. The radiation source may be a UV lamp that emits UV radiation having a peak irradiance ranging from about 350 mW/cm² to about 20 W/cm²—including all values and sub-ranges there-between. In some embodiments, the radiation source may emit UV radiation having a peak irradiance ranging from about 350 mW/cm² to about 2,000 mW/cm²—including all values and sub-ranges there-between. In a preferred embodiment, the radiation source may emit UV radiation having a peak irradiance ranging from about 350 mW/cm² to about 1,000 mW/cm²—including all values and sub-ranges there-between. The radiation source may be a mercury vapor UV lamp or an LED emitting radiation lamp, wherein the radiation that is emitted has a wavelength in the range of about 350 nm to about 400 nm—including all values and sub-ranges there-between. The LED may emit radiation at a wavelength ranging from 365 nm to 395 nm and have a LED peak irradiance as high as 20 W/cm² using a Nobel Probe.

Moving along the machine direction at the above referenced line speed, the putty composition applied to the cellulosic substrate 100 can be cured with UV radiation from the radiation source, wherein the UV radiation output required to cure the putty composition (including complete through cure) totals to an amount ranging from about 300 mJ/cm² to about 1000 mJ/cm²—including all values and sub-ranges there-between. Additionally, the putty composition may be cured with as little as a single pass under the radiation source. In other embodiments, the cellulosic substrate 100 having the putty composition applied thereto may be cured by passing underneath the radiation source with multiple passes—e.g., 2 to 10 passes—including all value and sub-ranges there-between.

The radiation source may comprise one or more UV lamps (including an LED) having a UVA output of greater than about 700 mJ/cm². The radiation source may be an LED emitting radiation having a wavelength in the range of about 350 nm to about 400 nm—including all values and sub-ranges there-between wherein the LED may emit radiation at a wavelength ranging from 365 nm to 395 nm and have a LED peak irradiance as high as 20 W/cm².

The composite panel 1 may then be cooled at a surface temperature ranging from about 54° C. to about 63° C.—including all temperatures and sub-ranges there-between.

In a preferred embodiment, the cellulosic substrate 100 having the putty composition applied thereto can be cured with a single pass under the radiation source, which provides for a continuous manufacturing process of flooring materials and products that further includes defect repair. Stated otherwise, using the putty composition of the present invention provides a useful way to repair surface defects 150 in cellulosic substrates 100 without having to temporarily separate the cellulosic substrate 100 from a continuous manufacturing process—e.g., stopping in-line flooring material manufacture so that a cellulosic board may be removed from the in-line production and relocated to a separate isolated repair process. Rather, defects 150 in cellulosic substrates 100 can be repaired along the overall continuous manufacturing process such that the defects can be repair immediately after the initial processing of the cellulosic board (e.g., board milling) and immediately before further processing steps (e.g., board sanding, additional cutting, surface staining and/or sealing) without the need to pause the overall manufacturing process for surface defect repair. With a single pass, the defects in the cellulosic substrate can be repaired along a conveyor otherwise intended to shaping, sanding, and/or staining the cellulosic substrate in an effort to create a flooring material.

In non-limiting embodiments, a flooring panel may comprise the composite panel 1 of the present invention. The flooring panel may further comprise an underlayment applied to the second major surface 2 of the composite panel 1. The flooring panel may further comprise a wear layer applied to the first major surface 1 of the composite panel 1.

The invention will be described in greater detail by way of specific examples. The following examples are offered for illustrative purposes and are not intended to limit the invention in any manner.

### EXAMPLES

Described in Tables 1 and 2 (below) are the compositions of four (4) exemplary putty compositions of the present invention (Ex. 1-Ex. 4), along with the compositions for three (3) comparative putty compositions (Comp. Ex. 1-Comp. Ex. 3).

Each sample was prepared by first performing a pre-heat step to each cellulosic substrate before application of the putty composition. The pre-heat step included passing the cellulosic substrate under UV lamps to achieve a board surface temperature (BST) of 37° C. to 55° C. prior to application of the putty compositions. Subsequently, each putty composition was applied to and filled defects on a cellulosic substrate by using either a plastic dropper or another dispensing device. The defects included knot holes having a depth of about 80 mil. The board was then passed under UV lamps with a UVA output of 730 mJ/cm² using an EIT Power Puck.

TABLE 1

| | Ex. 1 | Ex. 2 | Ex. 3 | Ex. 4 | Comp. Ex. 1 | Comp. Ex. 2 | Comp. Ex. 3 |
|---|---|---|---|---|---|---|---|
| Ingredient | Wt. % | | | | | | |
| UV curable* epoxy acrylate | 45.67 | 60.43 | 74.32 | 61.99 | 85.58 | 93.27 | 64.40 |
| oligomer | | | | | | | |
| UV curable* Urethane acrylate | 45.84 | 32.41 | 19.32 | 33.38 | 7.31 | 0.0 | 34.68 |
| oligomer | | | | | | | |
| 2,2′Azobis(2,4- | 0.46 | 0.73 | 0.58 | 1.10 | 0.62 | 0.59 | — |
| dimethylvaleronitrile) | | | | | | | |
| Acetone | 1.78 | 1.22 | 1.24 | 2.65 | 1.31 | 1.24 | — |
| Surfactant** | 0.18 | 0.34 | 0.32 | 0.88 | 0.42 | 0.40 | 0.92 |
| Colorant | 6.06 | 4.87 | 4.21 | — | 4.75 | 4.50 | — |
| Through Cure*** | Yes | Yes | Yes | Yes | Yes | Yes | No |
| Cracks on Cooling | No | No | No | No | Yes | Yes | N/A |

*Ingredient contains photo initiator
**Surfactant includes polyether modified polydimethylsiloxane
***Absence of “through cure” is confirmed by the oozing of uncured putty from the sides of a defect after the defect is pressed.

TABLE 2

| | Ex. 1 | Ex. 2 | Ex. 3 | Ex. 4 | Comp. Ex. 1 | Comp. Ex. 2 | Comp. Ex. 3 |
|---|---|---|---|---|---|---|---|
| Feed Speed (fpm) | 33 | 33 | 33 | 33 | 33 | 33 | 33 |
| Lamp Radiation | 730 | 730 | 730 | 742 | 730 | 730 | 742 |
| UVA Output (mJ/cm²) | | | | | | | |
| Peak Irradiance (mW/cm²) | 463 | 463 | 463 | 463 | 463 | 463 | 396 |
| # Passes | 1 | 1 | 1 | 1 | 1 | 1 | 1 |
| Depth of Defect | 80 mil | 80 mil | 80 mil | 80 mil | 80 mil | 80 mil | 80 mil |
| Through Cure | Yes | Yes | Yes | Yes | Yes | Yes | No |
| Cracks on Cooling | No | No | No | No | Yes | Yes | N/A |

As shown in Table 1, the exemplary compositions of the present invention (Ex. 1-Ex. 4) have no perceivable cracks upon cooling and demonstrate through cure; whereas Comp. Ex. 1 and 2 become brittle upon cooling and crack; and Comp. Ex. 3 does not demonstrate through cure. A putty composition that cracks upon cooling, or fails to demonstrate through cure, is unacceptable.

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

1. A composite panel comprising a first major surface opposite a second major surface, the composite panel further comprising:
a cellulosic substrate comprising a top surface opposite a bottom surface, the top surface forming a part of the first major surface, the cellulosic substrate comprising at least one defect that forms a depression in the top surface of the cellulosic substrate;
a cured polymeric composition formed from a putty composition comprising:
a first reactive component comprising a first acrylate oligomer;
a second reactive component comprising a second acrylate oligomer, the second acrylate oligomer comprising a urethane acrylate oligomer; and
an initiator component comprising a thermal initiator and a photo initiator;
wherein the first reactive component and the second reactive component are present in a weight ratio ranging from about 4:1 to about 1:2; and wherein the putty composition is self-leveling;
wherein the cured polymeric composition occupies at least a portion of the depression.

2. The composite panel according to claim 1, wherein the putty composition has a viscosity ranging from about 500 cP to about 10,000 cP at about 25° C.

3. The composite panel according to claim 1, wherein the first acrylate oligomer is selected from a polyester acrylate oligomer, an epoxy acrylate oligomer, or a combination thereof.

4. The composite panel according to claim 1, wherein the weight ratio of the first acrylate oligomer to the second acrylate oligomer ranges from about 2:1 to about 1:1.

5. The composite panel according to claim 1, wherein the putty composition is substantially free of calcium carbonate, talc and clay.

6. The composite panel according to claim 1, wherein the thermal initiator is present in an amount ranging from about 0.2 wt. % to about 1.5 wt. % based on the total weight of the putty composition.

7. The composite panel according to claim 1, wherein at least one of the first reactive component or the second reactive component comprises a reactive diluent.

8. The composite panel according to claim 1, wherein the cured polymeric composition is present in the depression such that the cured polymeric composition forms a part of the first major surface.

9. The composite panel according to claim 1, wherein the depression has a floor at a maximum depth of about 100 mil as measured from the top surface cellulosic substrate in a direction extending from the top surface toward the bottom surface.

10. A method of repairing a cellulosic substrate comprising:
(a) heating a cellulosic substrate having at least one defect that forms a depression in a top surface of the cellulosic substrate to a temperature of greater than about 35° C.;
(b) applying a putty composition to the depression, the putty composition comprising:
a first reactive component comprising a first acrylate oligomer;
a second reactive component comprising a second acrylate oligomer comprising a urethane acrylate oligomer; and
an initiator component comprising a thermal initiator and a photo initiator;
wherein the content ratio of the first reactive component to the second reactive component ranges from about 4:1 to about 1:2; and wherein the putty composition is self-leveling; and
(c) exposing the cellulosic substrate to a radiation source.

11. The method according to claim 10, wherein the putty composition has a viscosity ranging from about 500 cP to about 10,000 cP at about 25° C.

12. The method according to claim 10, wherein the weight ratio of the first acrylate oligomer to the second acrylate oligomer ranges from about 2:1 to about 1:1.

13. The method according to claim 10, wherein the cellulosic substrate is heated to a temperature ranging from about 35° C. to about 70° C.

14. The method according to claim 10, wherein the radiation source comprises a UV lamp having a UVA output of greater than about 700 mJ/cm².

15. The method according to claim 10, wherein the putty composition is substantially free of calcium carbonate, talc and clay.

16. The method according to claim 10, wherein the cellulosic substrate comprises a bottom surface opposite the top surface and wherein the putty composition is self-leveling such that during step (b) the putty composition fills the depression under gravitational pull and a top portion of the putty composition is substantially coplanar with the top surface of the cellulosic substrate.

17. The method of claim 16, wherein the depression has at a maximum depth of about 100 mil as measured from the top surface cellulosic substrate in a direction extending toward the bottom surface.

18. A putty composition comprising:
a first acrylate oligomer comprising a polyester acrylate oligomer, an epoxy acrylate oligomer, or a combination thereof;
a second acrylate oligomer comprising a urethane acrylate oligomer; and
an initiator component comprising:
a thermal initiator; and
a photo initiator;
wherein the first acrylate oligomer and the second acrylate oligomer are present in a weight ratio that ranges from about 4:1 to about 1:2; and wherein the putty composition is self-leveling; and wherein the putty composition has a viscosity ranging from about 500 cP to about 10,000 cP at about 25° C.

19. The putty composition according to claim 18, wherein the weight ratio of the first acrylate oligomer and the second acrylate oligomer ranges from about 2:1 to about 1:1.

20. The putty composition according to claim 18, wherein the putty composition is substantially free of calcium carbonate, talc and clay.
